(19) United States
(12) Patent Application Publication
(10) Pub. No.: US 2003/0142783 A1
(43) Pub. Date: Jul. 31, 2003

(54) DEVICE AND METHOD FOR TOMOGRAPHY AND DIGITAL X-RAY RADIOGRAPHY OF A FLEXIBLE RISER

(75) Inventors: Alf Daaland, Melhus (NO); Charles R. Smith, Libertyville, IL (US); Christian Frederik Otto Hagemann, Stavanger (NO)

Correspondence Address: FOLEY AND LARDNER, SUITE 500, 3000 K STREET NW, WASHINGTON, DC, 20007, US

(73) Assignee: STATOIL ASA

(21) Appl. No.: 10/062,565

(22) Filed: Feb. 5, 2002

(30) Foreign Application Priority Data
Jan. 28, 2002 (NO) 2002.0452

(51) Int. Cl. G01B 15/02; G01N 23/06

(52) U.S. Cl. 378/55

(57) ABSTRACT

An x-ray radiography tomography device for a flexible riser, particularly a riser end fitting on a riser hangoff block on a petroleum platform, the x-ray radiography device comprising the following features:

a) an x-ray source (1) of about 6 to 9 MeV arranged for directing said x-rays generally through an adjacent and an opposite sidewall portion of said riser;

b) a collimator (2) arranged between said x-ray source (1) and said sidewall of said riser pipe being adjacent to said source (1), said collimator (2) arranged for directing radiation said x-rays in a beam fan generally extending in a plane perpendicular to a long axis of the riser;

c) a sensor array (3) for receiving said x-ray beam fan after passage throug said riser pipe, said array comprising a plurality of scintillation detectors (30), said sensor array (3) arranged generally opposite of said source (1) with respect to said riser tube, and extending along a line extending generally perpendicular to said axis of said riser;

d) an internal frame (7) for rotating the x-ray source (1), the collimator (2) and the sensor array (3) generally about said axis of said riser, said framework arranged on a circular guide rail (10) mounted around said flexible riser hangoff block.

### TECHNICAL AREA OF THE INVENTION

The invention relates to a device for x-ray radiography of a flexible riser for a petroleum platform for producing petroleum fluids from a well in the seabed. More particularly, the invention relates to a mobile x-ray radiography apparatus for flexible risers, and a method for conducting the x-ray radiography using such an apparatus. The apparatus for X-ray tomography and digital radiography is used and the method is applied at both the parts of the riser constituting endpieces, a so-called end fitting, but the apparatus may be modified for use on the flexible riser portions, both the dry part extending above the sea, or even the submerged part of the flexible riser. The purpose of the invention is to provide information about the integrity of the fine structure of the riser to prevent leakage and damage due to mechanical deformation or chemical alterations.

### KNOWN ART

U.S. Pat. No. 4,725,963 describes an apparatus and a method for non-contacting non-destructive testing (NDT) online dimensional analysis and flaw detection of tubular products. The apparatus includes penetrating radiation sources and detectors arranged in a horizontal triangular pattern about a vertically arranged tube, all illustrated in U.S. Pat. No. 4,725,963 FIG. 1. The system employs computer tomography to provide high-precision dimensional estimates and flaw detection. The apparaus can continuously determine the outside diameter, inside diameter, wall thickness, ovality, eccentricity and weight-per-length of the tube over a wide range of temperatures of tubes produced on continuous basis. One essential feature is the three horizontally arranged x-ray detector arrays on the sides of the triangle, receiving the radiation which has penetrated the walls of the vertical tube, or strayed off the tube. Because of the variation in the expected radial opacity profile as expected for a penetrating ray, illustrated in U.S. Pat. No. 4,725,963 FIGS. 6a abd 6b and in U.S. Pat. No. 5,420,427 FIG. 18B and in FIG. 19a, the dynamic range of the sensor array must be very broad in order to obtain the information about fine structure. Also, stray radiation may arise in the side areas where the radiation is near tangential to the pipe. The stray radiation may be blocked by filters on the sensor arrays, and all undesired, dangerous radiation may be prevented by arranging the entire radiography instrument inside a concrete shield having a wall thickness of about 2 metres or more.

Experiments conducted by the inventors using a source radiating X-rays with intensity about 6 MeV has given good digital x-ray image scans and also good tomographic images of an reinforced flexible riser pipe. However, for radiometric inspection of a flexible riser in situ, i.e. on a producing production platform, the apparati of the known art are not safely nor feasibly applied. One may not turn an installed and producing riser except with great effort, which may destroy the riser pipe end. In the hangoff area at the production deck of the platform, several riser end fittings are grouped, and there is no space for heavy shields around each riser as may be provided in a purpose-built production laboratory on a production site on land. There may not be structural support for such apparatus of the known art, and certainly not for the shielding of apparatis of the known art, to protect workers on the platform. Reducing the radiation shield thickness would incur a risk of unacceptably high radiation doses for the workers. Also, measurements conducted by sensors near the hangoff area of the riser may be negatively affected by the stray radiation from the instruments of the known art, as they radiate past the periphery of the inspected pipe.

### SHORT SUMMARY OF THE INVENTION

A possible solution to the above mentioned problems is an x-ray radiography tomography device for a flexible riser, particularly a riser end fitting on a riser hangoff block on a petroleum platform, the x-ray radiography device comprising the following features:

a) an x-ray source (1) of about 6 to 9 MeV arranged for directing said x-rays generally through an adjacent and an opposite sidewall portion of said riser;

b) a collimator (2) arranged between said x-ray source (1) and said sidewall of said riser pipe being adjacent to said source (1), said collimator (2) arranged for directing radiation said x-rays in a beam fan generally extending in a plane perpendicular to a long axis of the riser;

c) a sensor array (3) for receiving said x-ray beam fan after passage throug said riser pipe, said array comprising a plurality of scintillation detectors (30), said sensor array (3) arranged generally opposite of said source (1) with respect to said riser tube, and extending along a line extending generally perpendicular to said axis of said riser;

d) an internal frame (7) for rotating the x-ray source (1), the collimator (2) and the sensor array (3) generally about said axis of said riser, said framework arranged on a circular guide rail (10) mounted around said flexible riser hangoff block.

An important advantage of the invention is that the resulting device of the preferred embodiment can be rather light and compact so it may be transported by helicopter (or ship) to a production platform and mounted at one by one riser end fitting to analyze the integrity of each particular end fitting while producing. Even more favourable the varying penetration depth for the x-rays which has a rather wide range, as illustrated in FIG. 8, can be compensated for by presetting the gain of the scintillator output, as opposed to the profiles of U.S. Pat. No. 4,725,963 FIGS. 6a abd 6b and in U.S. Pat. No. 5,420,427 FIG. 18B and in FIG. 19a.

Rotating the source and the linear sensor array about the axis of the riser may produce several linear radiographic images which may be combined to a two-dimensional scanned image covering the entire circumference of the riser. Shifting the source and the sensor array sideways or lengthways will illuminate each section of the riser in a manner which the data from the linear sensor array can be combined to a tomographic image as illustrated in FIG. 9.

Other important advantages of the invention is that the rather narrow beam fan neccesary to radiate only a part of the riser end fixture (about one half of the cross-section of the riser end fixture) will incur less stray radiation. This narrow fan does not pass through all parts of the riser end fixture at a time, but this lack is compensated for by rotating the entire source and receiver system about the axis of the riser end fitting in order to reach all parts and all projection angles through the riser end fitting.

### FIGURE CAPTIONS

The invention is illustrated in the attached drawings, in which a preferred embodiment of the invention is illustrated.

FIG. 1 is an isometric general view of an embodiment of the invention with a mounting bracket attached around a riser end fitting. The riser end fitting is here surrounded by a klystron (rear left) connected to an x-ray source (rear right) which illuminates through a selected section of a riser end fitting extending vertically. A linear sensor array on the opposite side can be seen (front left). The apparatus of the invention is arranged rotatable on a circular rail for being moved about the axis of the riser end fitting, and is designed movable to other riser end fittings one by one for analyzing each particular end fitting instead of permanent installation.

FIG. 2 is a vertical cross-section through a plane at a distance from the axis of the riser end fitting, the plane cutting through the axis of the source and the receiver array, illustrating the riser end fitting hanging on an end fitting flange on top a circular riser hangoff block.

FIG. 3 is a top view showing the riser end fitting in centre, the klystron below, the source partially hidden by a circulator slightly low of left, and a detector block with scintillator detectors slightly above and right. The cutout extending upwards on this drawing is the outline for the internal framework holding the x-ray system and arranged for being slid sideways onto the riser end fitting to surround it when mounted with the mounting bracket and a gear drive.

FIG. 4 is an isometric view of the apparatus seen from above the horizontal, from the klystron's side, and showing the detector block to the right. Note the vertical movement actuators extended on the framework and situated to the extreme right of the detector block. Another vertical actuator is arranged in the lower left of the view, outside of the klystron block.

FIG. 5 is a horizontal section view of the end-fixture of the riser end fitting, showing the area to be analyzed between the source and the scintillator detector array which was illustrated in FIGS. 1 and 2. The source is arranged to radiate the section of the riser end fitting through the near and the far wall part, slightly from across the riser end fitting's center and to near the outer wall here shown above center of the illustrated riser end fitting, radiating a slightly wider beam fan, e.g. a width of 28-30 degrees, than what is illustrated in the drawing. Advantageously the beam should not radiate through very close to the periphery of the riser end fitting, as this would give a very short penetration path near the periphery and would reqire a disadvantageously high dynamic range for the scintillator detectors, and also incur undesired side scattering of the beam. In FIG. 5 the device axis of the radiation source is arranged in-line with the center of the desired radiation beam fan and lying generally in the horizontal plane illustrated. As illustrated, even more space is allowed if a 90 degrees bent ray path from a horizontal source is used.

FIG. 6 illustrates generally the same section of the system as FIG. 5, but here more space is allowed for the beam fan on the source side of the riser end fitting because a vertical-axis source may be applied. However, a bent ray path would require a ray bending device like a magnetic fields requiring both energy and space and adding weight to the apparatus and introducing further complexity.

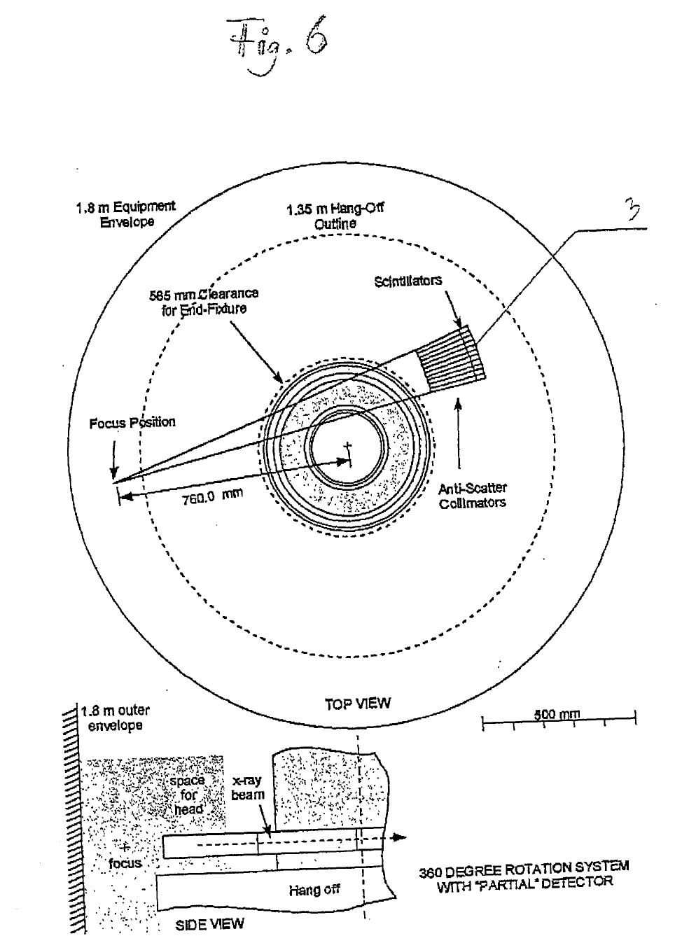

FIG. 7 illustrates a section of the circular linear movement rail with a rail-running block running on integrated caged ball belts designed to carry the heavy load of the apparatus with little friction. The apparatus may have a total weight of about 500 to 1000 kg including heavy major parts as control unit, signal generator, klystron, circulator, x-ray source, collimators and mounting bracket, guide rail and gear drive. The collimators may be made in wolfram (tungsten), iridium or even lead, all having very high specific weight.

FIG. 8 is a comparison between the detector output with flat gains and with adjusted gains.

FIG. 9 illustrates tomographic images calculated according to the method of the present invention.

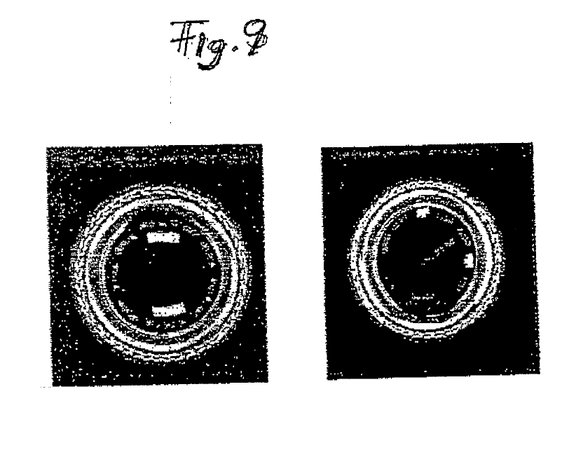

### DESCRIPTION OF A PREFERRED EMBODIMENT OF THE INVENTION

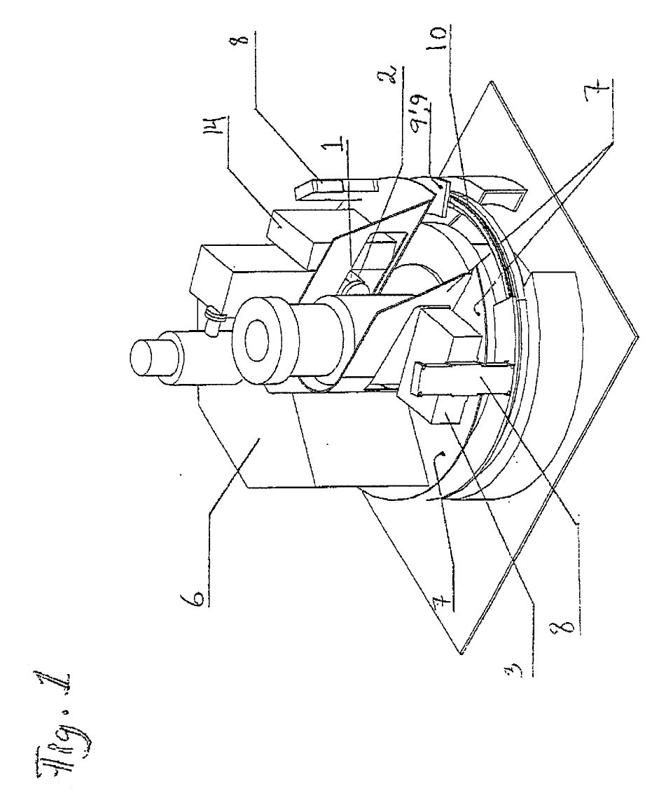

FIG. 1 illustrates a preferred embodiment of the intention on a mounting bracket attached around a riser end fitting. The riser end fitting is here surrounded by a klystron (6) connected to and powering an x-ray source (1) which radiates s-rays of about 6 to 9 MeV through a selected section of a riser end fitting extending vertically. The source may be a linear accelerator of the S-band type or the X-band type, or a cyclotron. Passive sources carrying nuclear isotopes do not have sufficient energy for the particular purpose of the invention, which may require a radiation of about min. 1000 Rad/min. A linear sensor array (3) on the opposite side of the source can be seen in FIG. 1. The apparatus of the invention is arranged rotatable on a circular rail (10) for being moved about the axis of the riser end fitting, and is designed movable to other riser end fittings one by one for analyzing each particular end fitting instead of permanent installation. Typically, a petroleum production platform may be provided with 10 to 20 production risers having their end fittings through riser hangoff blocks on the production deck.

The x-ray radiography device comprising the following features:

a) An x-ray source (1) of about 6 to 9 MeV arranged for directing said x-rays generally through an adjacent and an opposite sidewall portion of said riser. Near the periphery of the riser, the ray will penetrate a portion of the riser which is both the near and far portion of the sidewall without separation by the riser pipe central cavity.

b) A collimator (2) is arranged between the x-ray source (1) and the near sidewall of said riser pipe being adjacent to said source (1). The collimator (2) is arranged for directing the radiation, i.e. the x-rays in a beam fan generally extending in a plane perpendicular to the long axis of the riser.

c) A sensor array (3) is arranged for receiving the x-ray beam fan after passage through the riser pipe. The array comprises a plurality of scintillation detectors (30), and the sensor array (3) is arranged generally opposite of the source (1) with respect to said riser tube. The array (3) extends along a line extending generally perpendicular to said axis of said riser, i.e. the array of the preferred embodiment extends generally in the horizontal.

d) An internal frame (7) carries all the above mentioned source and detector devices. The frame is made for rotating the x-ray source (1), the collimator (2) and the linear sensor array (3) generally about said axis of said riser. The frame (7) is arranged to rotate directly or indirectly on a circular guide rail (10) mounted around said flexible riser hangoff block. Indirectly, the frame (7) may be arranged on linear acuators (8) on an auxiliary ring frame (9) again arranged to rotate on the guide rail (10), in order to analyze a section in a desired height of the riser end fitting.

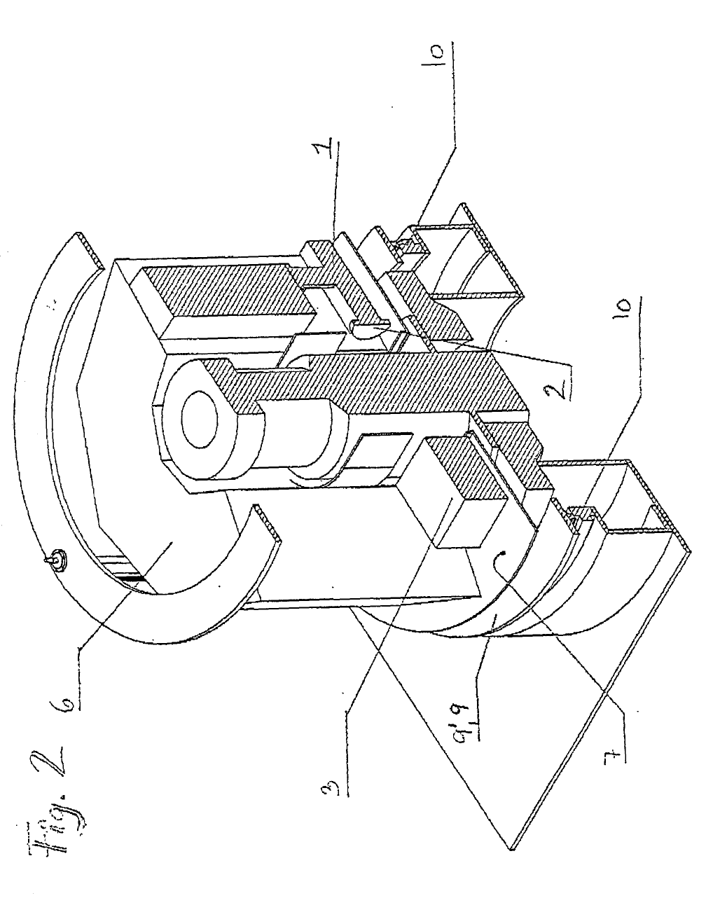

FIG. 2 illustrates a section plane at a distance from the axis of the riser end fitting. The plane cuts through the axis of the source (1) and the receiver array (3). The riser end fitting hangs on an end fitting flange on top of a circular riser hangoff block most commonly placed on the production deck where the risers enter from the sea below.

Klystrons belong to the known art. A klystron amplifies an electrical signal to produce a microwave which is led into the accelerator or radiation source.

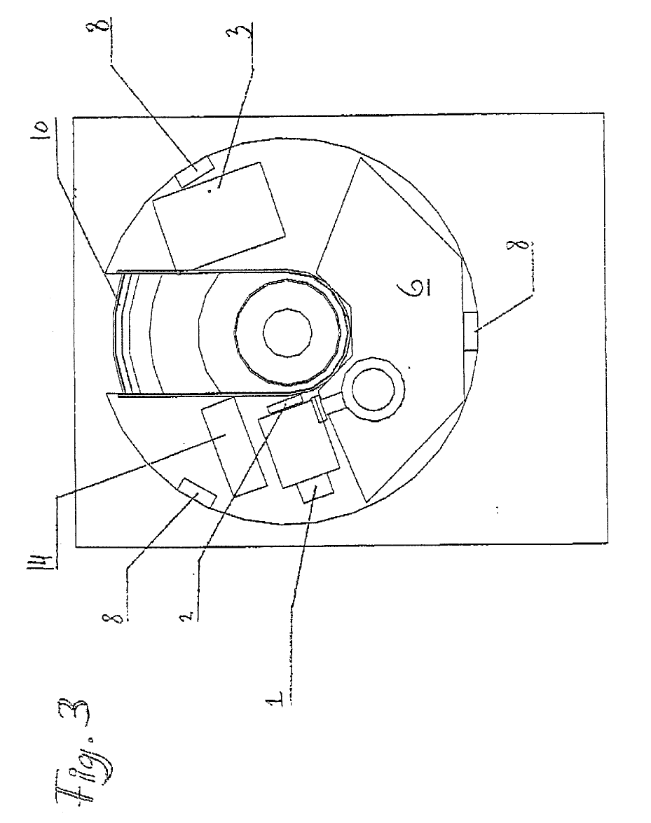

FIG. 3 is a top view showing the riser end fitting in centre, the klystron (6) below, the source (1) partially hidden by a source cooling circulator slightly low of left, and a detector block (3) with scintillator detectors (30) shown slightly above and to the right. The cutout extending upwards on this drawing is the outline for the internal framework (7) holding the x-ray system and arranged for being slid sideways onto the riser end fitting to surround it when mounted with the mounting bracket and a gear drive on a circular rail (10).

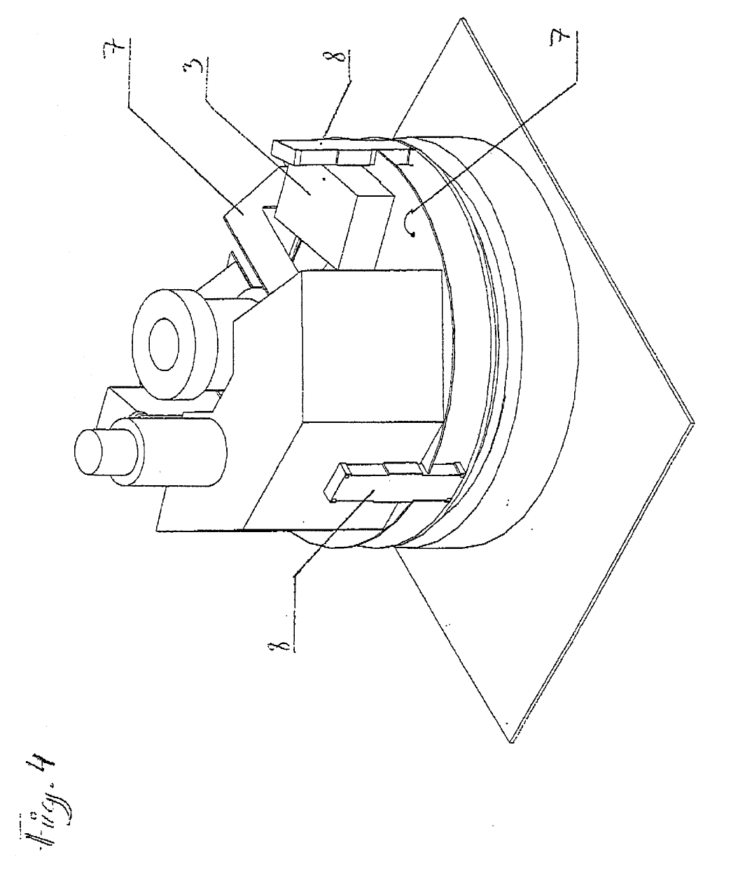

FIG. 4 is a view of the apparatus seen from above the horizontal, from the klystron's (6) side, and showing the detector block (3) to the right. Note the vertical movement actuators (8) extended on the framework between the toolholding frame (7) and the secondary plate (9′), the actuator shown to the extreme right of the detector block. Another vertical actuator (8) is arranged in the lower left of the view, radially outside the klystron (6) block. In the preferred embodiment of the invention there are 3 linear actuators.

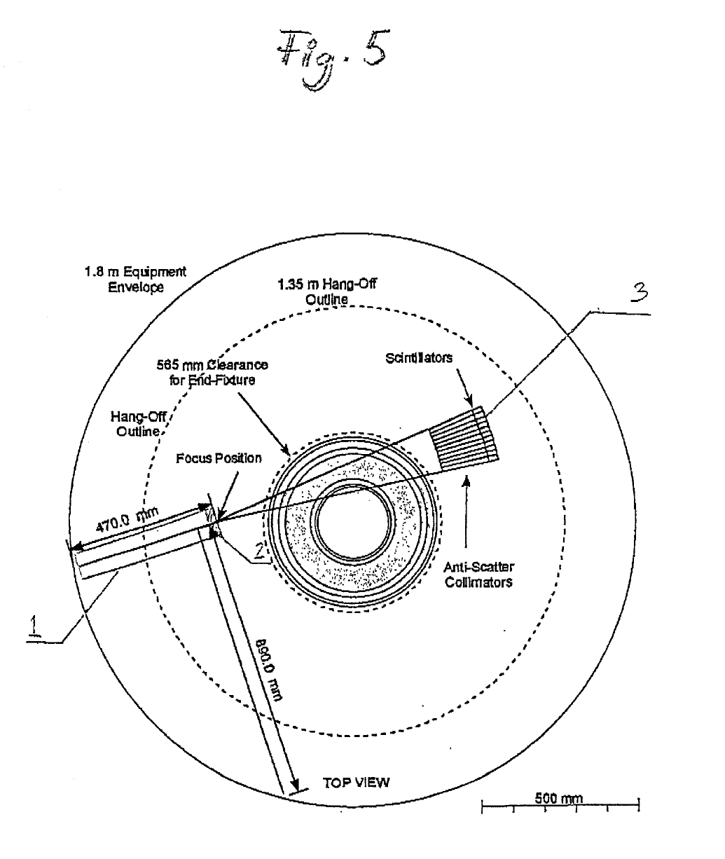

FIG. 5 shows the area to be analyzed between the source (1) and the scintillator detector array (3) which was illustrated in FIGS. 1 and 2. The source (1) is arranged to radiate the section of the riser end fitting through the near and the far wall part, slightly from across the riser end fitting's center and to near the outer wall, here shown above center of the illustrated riser end fitting, radiating a slightly wider beam fan, e.g. a width of 28-30 degrees, than what is illustrated in the drawing. Advantageously the beam should not radiate through very close to the periphery of the riser end fitting, as this would give a very short penetration path near the periphery and would reqire an enormously high dynamic range for the scintillator detectors, and also incur undesired side scattering of the beam. In FIG. 5 the device axis of the radiation source is arranged in-line with the center of the desired radiation beam fan and lying generally in the horizontal plane illustrated. As illustrated, even more space is allowed if a 90 degrees bent ray path from a horizontal source is used.

The source (1) is arranged to radiate a beam fan covering from near a periphery of said riser and across said riser axis, towards the said sensor array (3). The sensor array may be linear or arcuate as shown in FIG. 5. As mentioned above, the x-ray source (1) is powered by a klystron (6) amplifying a signal from a signal source, not illustrated. The signal source may be arranged in the electronics package (14) illustrated in FIGS. 1 and 2. In a preferred embodiment of the invention, a collimator is arranged in front of the array (3). This collimator is arranged for collecting the rays to enter radially towards the detector, and to reject bent or stray rays entering from undesired paths from other directions. The scintillator collimator may be made of wolfram, iridium, lead or similar heavy nuclei.

The source (1) and said linear array (3) is arranged on a ring-shaped rail (10) having its normal vector parallell with the axis of said riser. In other words, the ring rail is arranged horizontally. The source (1) and the sensor array (3) is arranged to be rotated together in their opposite attitute on the ring guide rail (10). The rotation takes place about the axis of the riser, for conducting radiography from different periphery angles along different transverse sections through the riser. A tomographic image calculated from a plurality of such sections may cover the entire section of a riser end fitting. An additional advantage is that the apparatus may be used for producing images also of the cross-section of the fluid flow passing through the riser end fitting, but this feature will not be follwed further in this specification.

The source (1) and the sensor array (3) is arranged to be moved in a combined motion about said axis of the riser and along the riser, for radiographic imaging of a desired length of the riser. In order to assure this combined motion the source and the sensor array can be arranged on an internal frame (7) which again is mounted on linear actuators (8) on a bearing ring rail (9′) with bearing blocks (9) running on said ring-shaped rail (10). The internal frame (7) is movable by means of the actuators (8) in a direction parallell with the riser axis, i.e. up and down along the riser end fitting according to the preferred embodiment of the invention.

A motor (13) is arranged for moving the internal frame (7) on the ring rail (10) with the source (1) and the sensor array (3) about said riser axis.

A radiation shield (5) arranged for blocking undesired radiation from the device, to protect people. This shield is arranged around the apparatus to block stray and direct x-rays from operators and other people.

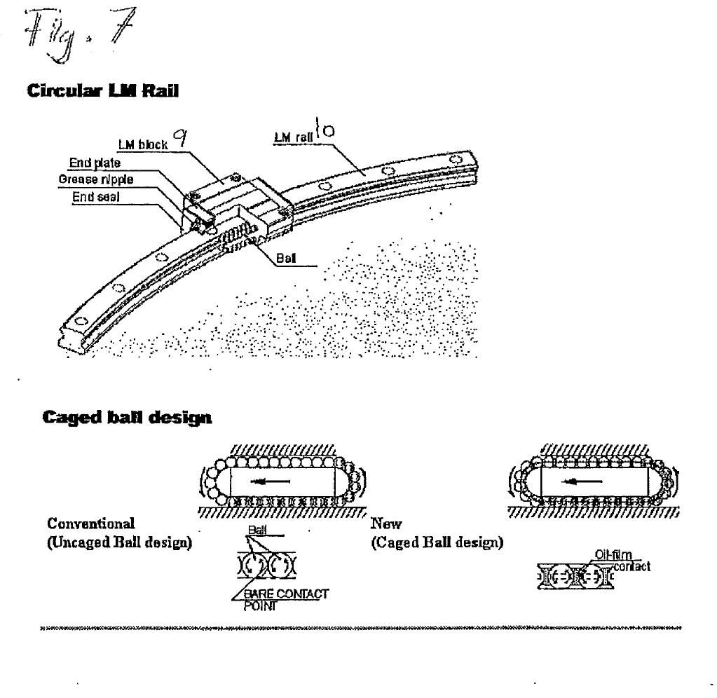

FIG. 7 illustrates bearing blocks (9) comprising flexibly caged ball bearings having bearing portions allowing several balls at a time to bear on the ring rail (10) and on the block (9). This arrangement is made in order to distribute weight on several balls and along a surface portion of said rail and said block. This arrangement will also build the secondary ring rail (9′) very low on the ring rail (10).

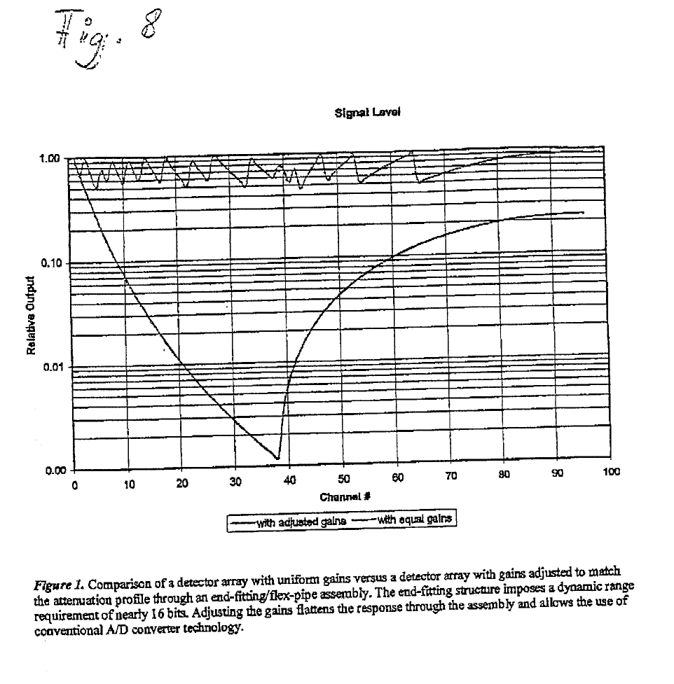

FIG. 8 is a comparison between the detector output with flat gains and with adjusted gains. FIG. 8 is a graph of a detector array with uniform gains versus a detector array with gains adjusted to match the attenuation profile through an end-fitting/flexpipe assembly. The end-fitting structure imposes a dynamic range requirement of nearly 16 bits. Adjusting the gains flattens the response through the assembly and allows the use of conventional A/D converter technology. This will improve the possibility to differentiate between the different densities between steel and plastic components in the tomographic images produced.

Detector Gain Adjustment for Flex Pipe CT Inspection.

The CT inspection of flex pipe through a large steel end-fitting imposes a dynamic range requirement on the detector array (3), which is difficult to achieve with conventional practice. At the peripheral edges of the end-fitting, the detector (3) must image the almost non-attenuated x-ray beam. At the inner tangent point between the end-fitting and the flex pipe, the path length through the steel end-fitting attenuates the x-ray beam by almost a factor of 60,000, or 16 bits.

The conventional design of industrial CT detector uses a single high speed AID converter to service all channels in the array through an analog multiplexing network. Typically, these converters provide 18 bits of range with 2 bits of electronic noise as the best possible performance. As a result, the maximum path length through the riser end fitting will result in a signal of zero and noise of 2 bits or more to produce a signal to noise ratio of zero. Critical flaws in the flex pipe are located very near this maximum path length and will not be detected with such a conventional type of detector system. In fact, the artificially high noise generated on these paths, due to the lack of A/D converter dynamic range, will be distributed over the entire image and may obscure any useful information. This problem can be overcome by presetting the gain of each individual detector channel according to the path length it will normally experience on a riser end fitting. This technique is possible since the end-fitting is always in place and has a cylindrical shape so that the path length seen by any individual detector remains constant as the CT system rotates around the end-fitting/flex-pipe assembly. Thus the gain of detector channels which measure the outside edges of the assembly are set to minimum values and the gains of the detector channels which measure the paths near the inner tangent point are set to higher values in such a way as to equalize the response of the detector array across the full diameter of the assembly. An example of this concept is shown in FIG. 8. In this case, a detector array with uniform gain smoothly curved line) is compared to a detector array with the gains of individual detector channels adjusted to match the attenuation of their respective path lengths through the assembly (shown in resulting zizag pattern). The gains in this example have been fixed using standard component values. As a result, the adjusted response is not perfectly flat but this type of variation can be compensated in software.

1. An x-ray radiography tomography device for a flexible riser, particularly a riser end fitting on a riser hangoff block on a petroleum platform, the x-ray radiography device comprising the following features:
a) an x-ray source (1) of about 6 to 9 MeV arranged for directing said x-rays generally through an adjacent and an opposite sidewall portion of said riser;
b) a collimator (2) arranged between said x-ray source (1) and said sidewall of said riser pipe being adjacent to said source (1), said collimator (2) arranged for directing radiation said x-rays in a beam fan generally extending in a plane perpendicular to a long axis of the riser;
c) a sensor array (3) for receiving said x-ray beam fan after passage through said riser pipe, said array comprising a plurality of scintillation detectors (30), said sensor array (3) arranged generally opposite of said source (1) with respect to said riser tube, and extending along a line extending generally perpendicular to said axis of said riser;
d) an internal frame (7) for rotating the x-ray source (1), the collimator (2) and the sensor array (3) generally about said axis of said riser, said framework arranged on a circular guide rail (10) mounted around said flexible riser hangoff block.

2. Device according to claim 1, in which said source (1) and said sensor array (3) is arranged to be rotated together in their opposite attitute on said guide rail ( ), said rotation taking place about said axis of the riser, for conducting radiography along different transverse sections through the riser.

3. Device according to claim 1, in which said source (1) or said sensor array (3) is arranged to radiate a beam fan covering from near a periphery of said riser and across said riser axis.

4. Device according to claim 1, said x-ray source (1) is powered by a klystron (6) amplifying a signal from a signal source.

5. Device according to claim 1, in said source (1) and said array (3) is arranged on a ring-shaped rail (10) having its normal vector parallell with the axis of said riser.

6. Device according to claim 2 and 3, in which the source (1) and the sensor array (3) is arranged to be moved in a combined motion about said axis of the riser and along the riser, for radiographic imaging of a desired length of the riser.

7. Device according to claim 5, with an internal frame (7) mounted on linear actuators (8) on bearing a bearing ring rail (9′) with bearing blocks (9) running on said ring-shaped rail (10), said internal frame (7) being movable by means of said actuators (8) in a direction parallell with the riser axis.

8. Device according to claim 7, with a motor (13) arranged for moving said internal frame (7) on said ring rail (10) with the source (1) and the sensor array (3) about said riser axis.

9. Device according to claim 1, with a radiation shield (5) arranged for blocking undesired radiation from the device, to protect people.

10. Device according to claim 7, said bearing blocks (9) comprising flexibly caged ball bearings having bearing portions allowing several balls at a time to bear on said ring rail (10) and on said block (9), in order to distribute weight on several balls and along a surface portion of said rail and said block.

11. Device according to claim 1, in which signals from individual detector channels will be signal amplified presetting according to the corresponding path length normally experienced or expected on a riser end fitting.
